(19) United States
(12) Patent Application Publication
(10) Pub. No.: US 2007/0243396 A1
(43) Pub. Date: Oct. 18, 2007

(54) Paper-film laminate

(76) Inventors: Elisabeth Buchbinder, Nideggen (DE); Axel Niemoller, Duren Niederau (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/644,676

(22) Filed: Dec. 22, 2006

(30) Foreign Application Priority Data
Dec. 22, 2005 (EP) EP 05 028 117.9

(51) Int. Cl. B32B 15/04

(52) U.S. Cl. 428/457

(57) ABSTRACT

The present invention relates to a 3-ply (paper or nonwoven)—metallized or colored/color-coated film—(paper or nonwoven) laminate having special visible features which guarantee recognition and anticounterfeit security, e.g., copy protection, of the composite material.

### BACKGROUND OF THE INVENTION

1. Field of the Invention

The present invention relates to a 3-ply (paper or nonwoven)—film—(paper or nonwoven) laminate having special visible features which guarantee recognition and anticounterfeit security, e.g., copy protection, of the composite material. These laminates can be used, for example, for the production of documents, flight luggage tags, entry tickets, labels, pouches, packaging materials, large-format advertising images, bills or posters, packaging tapes, and wall coverings. In particular they are suitable for use as tear-resistant envelopes, without being restricted thereto. The laminate is readily printable on one or both sides by analogue or digital printing techniques, such as by offset printing, gravioprinting, direct thermal printing, thermal transfer printing, inkjet printing, electrophotography, and laser printing with solid or liquid toners, for example, the printing mode of choice being dependent on the selection of the papers or nonwovens which are employed. The films that are used give the laminates outstanding tear resistance.

2. Description of the Related Art

Tear-resistant laminates of papers and films have long been known for the end uses indicated above. Viewed externally, these laminates have properties like those of normal papers or nonwovens: the inside film is not visible and as a result it is the paper (or nonwoven) character that occupies the foreground. Only when an attempt is made to tear the laminate is it possible to ascertain the presence of a film. The reinforcing action of the film is utilized by applications in which paper alone could not be used, or could be used but only with problems, on account of its inadequate mechanical strength. Certain of the applications require security features, in order to hinder or rule out counterfeiting, features which it has to date not been possible to realize in a 3-ply laminate of this kind. An example of such a feature is effective copy protection. In other applications recognition as a security or authenticity feature is important, so that the authenticity and integrity of the material can be recognized by the end user without auxiliary means. For example, the innovative material described herein can be used as an envelope for sending cheque cards or articles of value, since it is tear-resistant and since on account of the unique surface it is immediately possible to recognize the genuineness of the contents or, after opening, to confirm their genuineness, if the specific features are formed only on the inside. Tickets for entry or travel that are made from this material are immediately recognizable as authentic to anyone, and cannot be copied, since a copy on paper has neither the special structure of the surface nor the tear resistance. Existing 3-ply paper (nonwoven)-film-paper (nonwoven) laminates have extremely uniform surfaces with little structure, in order to emphasize the paper character. In that case security features must be applied subsequently, by means for example of costly and inconvenient printing with special printing inks, such as fluorescent inks, or by transfer of holograms from films printed accordingly. The new materials presented here contain their own security features without substantial added costs, and therefore, for a variety of applications, allow inexpensive solutions, or can be utilized as an additional security feature.

EP-A 689 181 describes a wet lamination process for paper-film laminates that describes the steps of corona treatment of the film, coating of the film with water-based adhesive, and uniting of the wet film web with a paper in a pressurized nip. The entire process is performed at a temperature which does not alter the orientation properties of the film. The intended uses of the laminates, including a 3-ply paper-film-paper laminate, include the envelope utility.

EP-A 011 274 describes a packaging material for containers that consists of a laminate of paper and plastic film which have been bonded by a melted resin adhesive without the use of solvents.

U.S. Pat. No. 3,669,822 describes a film laminate with a thin tissue paper, which is produced by means of an aqueous adhesive applied by spraying.

DE 19535831 describes a transparent laminate of two thin, transparent papers which are laminated dry by means of solventborne adhesive on both sides to a film which has already been coated on both sides with adhesive and dried. Aqueous adhesives in wet lamination cannot be employed for transparent paper, since on contact with water these papers tend to wrinkle.

U.S. 2005/0112345 A1 describes a translucent 3-ply laminate of an oriented polymer film with two thin papers having a basis weight of between about 13 g/m² and 24 g/m². Objects which come into contact with the laminate are visible through the laminate. Intended uses specified are as packaging material, envelopes, restaurant menu cards, and book dust jackets. An advantage here is the high printability of the laminate, the moisture resistance, and text with see-through legibility. The see-through properties can be modified by way of the paper used. In order to achieve the good see-through described, therefore, highly uniform papers must be employed.

U.S. Pat. No. 6,706,388 B2 describes a decorative packaging material composed of a paper-film laminate whose reverse carries a cold-seal adhesive. The decorative outside facing away from the adhesive, of either paper or film, depending on which side is coated with the adhesive, can be metallized. Papers described are those having a thickness of more than 75 μm. These described papers have a high opacity.

Publications U.S. 2001/0014392 A1, U.S. Pat. No. 6,235,386 B1 and U.S. Pat. No. 5,962,099 describe, in analogy to U.S. Pat. No. 6,706,388 B2, an adhesive tape having a pressure-sensitive adhesive rather than a cold-seal adhesive, it being possible for the outer surface of the plastic film to have been metallized.

In the products described in WO 02/064365, U.S. Pat. No. 6,699,541 B2, U.S. 2004/0209024, U.S. 2004/0166344, U.S. 2003/0037512 and U.S. 2003/0037511, metallized paper is used as an outer ply in a paper-film composite with cold-seal adhesive, in order to provide the packaging material with a decorative outer surface.

U.S. 2002/0068136 and U.S. Pat. No. 6,348,246 describe up to 5-ply composites comprising 2 films and further, optional papers, of which the outer film in the composite may have been metallized, in order to obtain a moisture barrier in a pack.

U.S. Pat. No. 5,565,252 discloses a paper-film-board composite having heat reflection function for lining ceilings and facing walls, the composite carrying metallization on the outer paper surface.

In U.S. Pat. No. 5,786,064 as well the outer surface of the paper in the paper-film composite may have been metallized. These last-mentioned documents describe metallized surfaces on the outside of the composite materials claimed. As a result, the paper-film composite materials have a strong, uniform, metallically reflective effect.

EP-A-1 586 447 describes the production of 2-ply and 3-ply laminates of the paper or nonwoven-film(-paper or nonwoven) combination, though without addressing the visual design of the paper and/or nonwoven and hence of the products obtained.

### SUMMARY OF THE INVENTION

It is an object of the present invention to provide a material which ensures unambiguous recognizability on account of its special surface, which can be used among other things as a security feature in various applications. A further object of the invention is to provide a material which is tear-resistant and can be processed like paper. Through the inventive selection of papers and films it is possible to provide individually structured materials provided with a security aspect.

This object is achieved by means of a non-see-through 3-ply paper-film-paper or nonwoven-film-paper or nonwoven-film-nonwoven laminate characterized in that the film carries a thin metal layer or color layer and at least one of the papers or nonwovens allows the metal layer to show through nonuniformly.

Surprisingly it has been found that 3-ply paper (nonwoven)-film-paper (nonwoven) laminates which on the film surface contain a metallization or application of color, and papers or nonwovens which have been structured in such a way as to allow the metal layer or color layer to show through partly, can be unambiguously identified by way of the metallic or color effect, are not easily counterfeited owing to the complex construction of the material, and are not copiable, since on scanning, photographing or in a copier (electrophotography) the metal effect or color effect cannot be captured. By varying films, papers and adhesive it is possible to develop different structures and colors and to adjust the properties of the product, such as thickness, stiffness, printability, tensile strength, for example. A feature common to all of the products of the invention is at least one surface which even over a small area has readily recognizable color differences, and which is characterized by the metallized or colored film, a possible varnish coating on the film, the applied adhesive, and the specific “cloudy”, generally very thin paper/nonwoven. In particular the color differences, measured at individual points on a DIN A4 sheet in comparison to the average value of 30 color values of that sheet, are greater than delta E equals 0.5, preferably greater than 1.0. Color differences of this kind are readily recognizable to the naked eye. The translucent metallization or color gives the surface a special or mirror effect or colored effect. The distribution of the color differences depends on the materials employed and on their processing, including, for example, the uniformity of the coat of applied adhesive, or the cloudiness of the papers or nonwovens that are used.

In principle it is possible to use all films to which a thin metal layer or color layer can be applied. These include films of polyolefins, such as polyethylene or polypropylene, polyamide, polyimide, polyester, polyurethane, polyvinyl chloride, polystyrene, polyacrylate, polycarbonate, cellulose derivatives, triacetylcellulose for example, including films of copolymers of the stated polymers, and also biodegradable films, made for example from starch or polyamino acids. These films may have been produced in a variety of ways and may be unoriented or uniaxially or biaxially oriented. Preference is given to biaxially oriented polypropylene (BOPP) films or films of polyethylene terephthalate (type designation e.g. Mylar or Melinex from DuPont) which are metallized under vacuum. These films have a particularly high tear resistance and high temperature stability and, as a result of the metallization, they acquire a highly mirrored surface. For reasons of cost, metallization is carried out in general using aluminum, although it is also possible for other metals such as silver, copper, gold, etc., to be applied by vapor deposition. The films may be transparent or colored, white for example. If the film is not transparent, the paper which is laminated in order to form the recognizable surface is adhered preferably on the metallized side of the film. The surfaces of the films may have been treated, by corona methods, by flaming, by chemical treatment or by coating, for example. Particularly in the case of BOPP films this leads to improved wetting and adhesion of the adhesive and therefore ensures a high composite strength. The thickness of the film is selected according to application. It can be between 6 μm and 300 μm, preferably between 12 μm and 100 μm.

The metal layer may optionally be provided with a thin varnish coating, which may also have a coloration. In this way it is possible in particular to produce colored surfaces with a metallic luster. Thus, for example, by giving a yellow color to a clear varnish of this kind over a film which has been vapor-coated with aluminum, it is possible to produce a gold effect or copper effect. A varnish coating of this kind typically has a thickness of 1 μm to 5 μm, although the thickness is not limiting for the invention.

As the adhesive it is possible to use commercially customary laminating adhesives which are selected according to the laminating method and to the application properties. Thus, for example, aqueous adhesives are suitable for wet and dry lamination, solventborne adhesives are suitable for dry lamination, and hotmelt adhesives, solvent-free one-component or multicomponent adhesives or radiation-curing adhesives are suitable. The adhesive coatweight lies in the range from 1 g/m² to 10 g/m², preferably in the range from 2 g/m² to 6 g/m², but is not limiting for the invention. The adhesive systems may comprise one or more additional components, crosslinkers for example. Through appropriate selection it is possible to obtain a composite which even under mechanical stresses, creasing for example, is not delaminated or else is water-resistant and hence suitable for outdoor applications. The adhesive may be applied nonuniformly, such as with a certain streakiness or cloudiness, for example. This effect is then recognized in addition to the metal effect or color effect, through the paper which has been laminated on. By this means, further design possibilities are obtained—for example, with additional decorative impression, or as an additional security feature. Nonuniform application of adhesive may be accomplished, for example, by means of roller application, in which fine structures form as a result of separation of the film in the roll nip. The selection of the adhesives or adhesive systems suitable for the particular desired application is within the scope of typical knowledge of a person skilled in the art of laminates, and is without restriction for the invention described here.

At least one of the two outer papers or nonwovens of the 3-ply composite is selected such that it is partially transparent such that the underlying metallization or color is visible at the transparent points. In order to achieve the nonuniformity of perceived color of the invention on at least one side of the composite, therefore, preference is given to selecting a cloudy or highly cloudy paper or nonwoven. Such papers are in general very thin and have a basis weight of 10 g/m² to 50 g/m², preferably 13 g/m² to 30 g/m². Examples of suitable papers include machine-glazed packaging papers, bible papers, tissue papers or cigarette papers. The papers may be white or have slight or strong coloring. If the papers have a smoother side it is preferred for that to be the side joined to the film by means of the adhesive. On one or both sides the film carries one or more thin metal layers or color layers, and, following lamination, at least one of the outer surfaces of the papers or nonwovens has points which exhibit a difference in color, delta E, of individual points of at least 0.5, preferably at least 1.0, in relation to the average value of the color values of 30 randomly distributed measurement points on a DIN A4 sheet.

One side of the composite may be adhesively bonded to a paper which has a uniform structure and may have a functional surface. Surfaces of this kind, which then lie on the side of the composite facing away from the film, are, in particular, readily printable in different printing processes. Thus for the lamination of this one side of the laminate it is possible to make use, among others, of coated or uncoated papers, heat-sensitive papers (thermal papers), inkjet papers, laser printing papers or thermal transfer papers. The basis weight of such papers can be between 25 g/m² and 150 g/m², preferably between 50 g/m² and 100 g/m². These papers may be colored or structured in order to produce particular effects, but do not on their own produce the effect according to the invention. They generally possess a uniform opacity and do not allow the metallization of the films to show through in such a way that an irregular, typical structure is apparent.

As an alternative to paper it is possible to use nonwovens. These non-woven, web-form fiber materials are to be preferred over paper particularly in instances when a plastic surface is more suitable, for example as packaging material for scratch-sensitive products; when one or both outer plys is or are to be water-resistant; or when a particularly high tear propagation resistance is desired. These nonwovens may be composed of natural fibers or polymeric fibers, such as polyolefins, polester, polyamide, for example, and may be obtained by dry laying, wet laying or spinning processes. They typically have a basis weight of between 10 g/m² and 300 g/m², with low basis weights being preferred for the application of the invention.

It is important for the selection of the papers or nonwovens that the opacity of the materials is subject to sufficiently severe fluctuations that the inventive effect of the visible color fluctuations is obtained on at least one of the outer surfaces of the composite material.

The products of the invention can be produced in conventional manner by known methods of coating, of metallizing and of laminating. With laminating in particular there are a variety of methods which lead to results each of similarly good effect. Mention may be made here of the following in particular: dry lamination methods with aqueous or solventborne adhesives, wet lamination methods with aqueous adhesives, solvent-free lamination with 1-component or 2-component adhesives, hotmelt lamination, and lamination with radiation-curing adhesives. Important economically is the production of the 3-ply composite in one operation. A method of this kind is described at length in EP-A 1 586 447, for example.

The products of the invention comprise an inside, metallized or colored film stuck to which on both sides is a nonwoven or paper. The film may be single-sidedly or double-sidedly metallized and/or colored and/or provided with a color layer. At least one of the papers/nonwovens is selected such that the effect according to the invention occurs: that is, the metallization/coloring of the film is partially visible through the paper. In the case of transparent films and of single-sided metallization or coloring it is not important which side carries the metallization/coloration, since the metal effect or color effect is visible even through the film. In the case of non-transparent films the metallization/coloration must have been applied to the side of the film that faces the paper selected for the effect. An optional possibility is for a varnish coating, which may also have been colored, to have been applied to the film, or to the metallized side of the film, on one or both sides, in order to achieve specific color effects, such as, for example, a gold effect through yellow coloring on a layer applied by vapor deposition of aluminum, or in order to protect the metal layer.

The 3-ply composites of the invention have particular properties which for a variety of applications exhibit advantages over conventional products such as single-ply or multi-ply papers, nonwovens or conventional 3-ply paper (nonwoven)-film-paper (nonwoven) composites. They have a high degree of tensile strength. Measured in accordance with ISO 2493, a tensile strength of between 40 N/15 mm and 3000 N/15 mm is obtained. If biaxially oriented polymeric films are used, a high tear resistance is obtained, and in that case the tear propagation resistance is generally low. With uniaxially oriented films a high tear propagation resistance is achieved only in the direction transverse to the orientation, whereas with non-oriented films or nonwovens both the tear resistance and the tear propagation resistance are good.

With selection of a suitable adhesive system it is possible to produce water-resistant and crease-resistant composites. By virtue of the metallization of the film the product of the invention acquires a very high opacity of more than 99%, and thus is impervious to the gaze.

This is important for numerous applications—for example, if the product packaged with the composite material, or the secured product, is not to be visible. The effect surface of the invention has a high recognition value and therefore represents an unambiguous genuineness and security feature which can be recognized immediately without further auxiliary means. Information printed on the surface cannot be duplicated by copying, scanning or photographing without the security feature of the metallization showing through non-uniformly disappearing in its effect. The laminate of the invention can therefore be used, for example, for entry tickets or travel tickets that are to be protected against counfeiting. As a result of the translucent metallic luster, moreover, it has a particular, high-value appearance. Depending on the paper or nonwoven selected it is also possible to produce decorative surfaces, colored surfaces for example. Through appropriate selection of the paper/nonwoven for the second side of the product it is possible to determine further properties of the product, by a selection for example of uniform papers, including thicker papers, with uniform opacity. It is thus possible to produce special paperlike materials which can be printed in all known analogue and digital printing processes.

Test methods:

Determination of the inventive recognition/security feature by colorimetry:

A DIN A4 sheet of the material of the invention is measured for color values L*, a* and b*, from the side on which the metallization shows through, in accordance with DIN 6174, by means of a colorimeter, e.g. from Gretag Spectroscan, using illuminant D50, 2° geometry and 4 mm measurement aperture, the measurements being carried out 30 times at locations distributed over the sheet. The average color of this sheet is obtained by forming average values from the 30 individual values L*, a* and b*, thus giving La*, aa* and ba*. For each of the individual values L*, a* and b*, a color difference delta E is determined with respect to the average color value, delta E being calculated as follows:
delta E=root((L*−Lₐ*)²+(a*−aₐ*)²+(b*−bₐ*)²)

This color difference is a measure of the differences in color at individual points on the sheet.

Opacity:

The opacity of the papers or composites used is determined in accordance with DIN 53146 (ISO 2471).

Composite Adhesion:

The composite adhesion is determined on the complete composite, by attempting to separate the paper from the film, either by hand or by means of a tensile testing machine, in the direction transverse to the web. For this purpose, the delamination attempt is preferably commenced at a web margin not coated with adhesive. The composite adhesion is excellent if the paper or film tears without delamination occurring.

Water resistance:

The complete composite is immersed in mains water at room temperature for 24 hours. It is water resistant if there is no delamination of the individual webs. For more demanding applications the composite must also not be delaminable when an attempt is made to peel the wet webs from one another. The test result is evaluated in grades from 1 to 5, the rating 1 standing for a non-delaminable composite and 5 for an easily delaminated composite.

Mechanical Strength:

Tear resistance and breaking load are determined in accordance with ASTM-D-1004 and ISO 1924.

### EXAMPLES

### Example 1

A biaxially oriented polypropylene film (OPP film) 30 μm thick and with corona pretreatment on both sides is vapor-coated with aluminum under vacuum. This film has an opacity of 98% and for lamination it is coated with an aqueous, crosslinkable acrylate adhesive on both sides and laminated wet to two different papers. One side is laminated with an 18 g/m² cigarette paper, the other with a 50 g offset printing paper. The opacity of the composite is more than 99%, and the tear resistance to ASTM D 1004-90] is 25 N in machine direction and 21 N in cross direction. The composite has very good composite adhesion and an excellent water resistance (grade 5). The average color values from 30 measured values in a DIN A4 sheet come out at Lₐ*=88.7, aₐ*=−0.4 and bₐ*=−0.5 on the side of the cigarette paper, with color differences delta E of up to 1.24, depending on the measurement site. The other side of the paper has average values of Lₐ*=91.9, aₐ*=−2.0 and bₐ*=−7.7 and a maximum difference in color of 0.36 among 30 measured values. The composite therefore has a very uniform paper side and an inventive, structured paper side on which the metallization shows partly through. The structure is directly recognizable and has a typical metallic effect. This structured side can be color-printed with an inkjet printer, but on a color copy produced with a laser color copier the structuring and the metallic effect are no longer visible, even if the reproduction brightness is varied. There is therefore effective copy protection.

### Example 2 (Comparative Example)

The lamination is carried out as in example 1 except that 50 g paper is laminated to both sides. The resulting composite has uniform coloring on both sides and a maximum color difference of delta E equals 0.4, which is not perceived as a particular structure. There is therefore no copy protection, since copies are too similar to the original, especially if paper with rougly the same coloration is used.

### Example 3

An OPP film 35 μm thick with aluminum metallization on one side (Manucor SIM met) is laminated in a first operation to the reverse of a matt 80 g paper that has good ink-jet printing properties by virtue of a pigment coating of its front face, lamination being effected by means of a solvent-based dry-laminating adhesive based on polyurethane, by the non-metallized side. In a second operation a 20 g polypropylene-based spunbonded nonwoven is laminated against the metallized side of the film. The adhesive coatweight is in each case 4 g/m² dry. On the nonwoven side the composite has good composite adhesion and water resistance (grade 4). On the paper side, composite adhesion and water resistance are excellent (grade 5). On the facing side (inkjet-printable side), on color locus measurement, the composite has on average color values (Lab values) of Lₐ*=93.2, aₐ*=2.1 and bₐ*=−6.2, and with 30 measured values has a maximum difference of delta E equals 0.2. On the reverse (the nonwoven side) the color values measured are on average Lₐ*=79.9, aₐ*=−0.1, bₐ*=−0.6. With 30 measured values the maximum difference delta E is 3.8.

The opacity is 100%; the tear resistance in machine and cross directions is 30 N; the breaking load is 110 N/15 mm in machine dirction and 173 N/15 mm in cross direction. The composite material is used as envelope material (wrapper) for scratch-sensitive products, e.g. cheque cards or CDs. By virtue of the inkjet coating it can be printed to outstanding effect by means of an inkjet printer. After the wrapper has been opened, it is immediately possible to ascertain that the particular structure is present on the inside, and hence counterfeiting is ruled out.

### Example 4

A white OPP film 38 μm thick and metallized with aluminum on one side (Metallyte MW280) is coated on both sides with an aqueous acrylate adhesive and laminated wet to two papers. The metallized side of the film is laminated with a 25 g paper (25 g/m²) with opacity fluctuations, and on the white side with a uniform 40 g paper. On the white side of the film the average color values from 30 measured values are Lₐ*=95.3, aₐ*=2.7 bₐ*=−7.6. For 30 measured values the maximum color difference delta E is 0.3. On the metallized side the average color values are Lₐ*=87.9, aₐ*=1.2 and bₐ*=−6-6. The maximum color difference delta E is 1.7.

Composite adhesion and water resistance are excellent on both sides (grade 5). The opacity is 99.8%. The breaking load is 130 N/15 mm in machine direction and 70 N/15 mm in cross direction.

The composite material can be used as a travel ticket for buses and trains or as an entry ticket for sport or concert events, for example. It has tensile strength and is therefore durable, in application for example as a long-term card or multi-journey ticket, and is readily printable on both sides, the structured side preferably being printed to such little extent that the color differences are still readily visible. This color structure is an effective means against counterfeiting, such as by copying, and can easily be identified by inspectors without auxiliary means.

### Example 5

A transparent polyester film 12 μm thick and with aluminum metallization on one side is coated with a yellow-colored varnish on the metallized side in order to achieve a gold effect. Owing to the high transparency of the film, the metallization is recognizable in silvery metallic form on the other side, the side not colored gold. Subsequently the film is coated on both sides in one operation with an aqueous, crosslinkable acrylate adhesive and is laminated on both sides to the same 24 g paper with sharp opacity fluctuations. On one side the resulting composite material has a structured appearance with regions which show through in a metallic aluminum color, while on the other side it has gold-colored regions showing through, with a structure similar to that on the first side. The opacity of the composite is 99%. The breaking load in machine and cross directions is 122 and 67 N/15 mm, respectively; the tear resistance is 20 N (machine direction) or 25 N/15 mm (cross direction). The average values of 30 L*, a* and b* color values in each case were found to be Lₐ*=88.2, aₐ*=1.2, bₐ*=6.8 on the silver side and Lₐ*=75.8, aₐ*=9.1, bₐ*=10.4 on the gold side. The maximum color difference delta E is 2.02 on the silver side and 5.88 on the gold side.

The composite material described can be put to uses which include its use as a decorative tag label, for price marking, or as packaging material, for producing packaging pouches, for example.

What is claimed is:

1. A laminate comprising 3-plys comprising first and second layers of paper or non-woven material;
a film disposed between the first and second layers and carrying a thin metal layer or a color layer, the metal layer being applied by a vacuum evaporation process and composed substantially of aluminum, copper, or silver;
at least one of the first and second layering allow the metal layer or color layer to show through nonuniformly, at least one of the first and second layers having an outer surface having locations which have a color difference delta E of at least 0.5 with respect to the average value of the color values of 30 randomly distributed measurement points on a DIN A4 sheet.

2. A laminate according to claim 1, wherein the color difference delta E is at least 1.0.

3. A laminate according to claim 1, further comprising adhesive holding the first, second and film layers together.

4. A laminate according to claim 1, wherein the film is a polyester film, a polypropylene film or a polyethylene film and has a thickness of about 6 μm to 300 μm.

5. A laminate according to claim 4, wherein the film has a thickness of about 12 μm to 100 μm.

6. A laminate according to claim 1, wherein at least one of the papers or nonwovens has a basis weight of about 10 g/m² to 50 g/m².

7. A laminate according to claim 1, wherein at least one of the papers or nonwovens has a low overall opacity and high fluctuations in opacity over its area.

8. A laminate according to claim 1, wherein at least one of the papers or nonwovens has a coating which enhances its printability.

9. A laminate according to claim 8, wherein at least one of the papers or nonwovens has a coating which is printable by inkjet printing, thermal printing, thermal transfer printing or laser printing.

10. A laminate according to claim 3, wherein between the film and an adhesive layer there is an applied varnish layer having a coloration.

11. A laminate according to claim 1, wherein the opacity of the 3-ply composite, measured to DIN 53146 (ISO 2471), is above 97%.

12. A laminate according to claim 1, wherein the breaking load of the 3-ply composite, measured to ISO 1924, is about 40 N/15 mm to 3000 N/15 mm.

13. A laminate according to claim 3, wherein the first or second layer comprises paper and adhesive between the metal layer and the paper has a nonuniform structure which is visible through the paper.
